(19) United States
(12) Patent Application Publication
(10) Pub. No.: US 2005/0185208 A1
(43) Pub. Date: Aug. 25, 2005

(54) Data providing apparatus and data providing mehtod

(75) Inventor: Kazumi Murata, Yokohama-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/784,166

(22) Filed: Feb. 24, 2004

(51) Int. Cl. G06F 15/00

(52) U.S. Cl. 358/1.14

(57) ABSTRACT

A data providing apparatus includes an input unit which inputs printing data, a setting unit which sets a selection condition, an acquiring unit which is connected to a network, and acquires a plurality of status information concerning a plurality of image forming apparatuses on the network, a selection unit which calculates evaluation of the plurality of image forming apparatuses on the basis of the selection condition and the plurality of status information, and selects one image forming apparatus according to the calculation result, and a transfer unit which transfers the printing data input by the input unit in order to provide the printing data to the one image forming apparatus selected by the selection unit. Data can be automatically provided to the optimum image forming apparatus on the network.

### BACKGROUND OF THE INVENTION

In recent years, as digital equipment has come into widespread use, networking for easily utilizing digital data has been introduced. As a result, operational performance of the digital equipment has been remarkably improved. In data printing which utilizes a network and a plurality of digital image forming apparatuses, an output port is selected from a personal computer (PC) of a user to output data in the conventional printing processing. In data providing, an MFP side to which the data is transmitted performs the provision in conjunction with a multi function pedestal (MFP) which can exchange information with one another.

Therefore, in the prior art, since it is necessary for the user to select the port to output the data in one of the plurality of MFPs (printer or the like), operation is complicated and a burden for the user. In the case where MFPs exchange information with one another, since it is necessary to transmit the data to a server or a master device of the MFPs, there is a problem that the operation becomes complicated.

### BRIEF SUMMARY OF THE INVENTION

It is an object of the invention to provide a data providing apparatus and a data providing method, which receive a printing task to select automatically one optimum printing device in printing devices on the network and transmit the printing task to the one optimum printing device when the printing environment which a user desires is set.

One embodiment of the invention is a data providing apparatus comprising an input unit which inputs printing data, a setting unit which sets a selection condition, an acquiring unit which is connected to a network, and acquires a plurality of status information concerning a plurality of image forming apparatuses on the network, a selection unit which calculates evaluation of the plurality of image forming apparatuses on the basis of the selection condition and the plurality of status information, and selects one image forming apparatus according to calculation result, and a transfer unit which transfers the printing data input by the input unit in order to provide the printing data to the one image forming apparatus selected by the selection unit.

### BRIEF DESCRIPTION OF THE SEVERAL VIEWS OF THE DRAWING

FIG. 1 is a block diagram showing an example of a configuration of a data providing apparatus according to the invention and an image forming apparatus connected thereto;

FIG. 2 is an explanatory view showing the data providing apparatus according to the invention and a plurality of image forming apparatuses connected thereto through a network;

FIG. 3 is a flowchart showing an example of providing operation of the data providing apparatus according to the invention;

FIG. 4 is a flowchart showing an example of the providing operation of the data providing apparatus according to the invention;

FIG. 5 is a flowchart showing an example of the providing operation of the data providing apparatus according to the invention;

FIGS. 6A and 6B are explanatory views showing an example of an operating screen of the data providing apparatus according to the invention;

FIG. 7 is an explanatory view showing an example of a monitor screen for monitoring the image forming apparatus of the data providing apparatus according to the invention;

FIG. 8 is an explanatory view showing another example of the monitor screen for monitoring the image forming apparatus of the data providing apparatus according to the invention; and

FIG. 9 is a view showing an example of evaluation calculation of a plurality of candidates of the data providing apparatus according to the invention.

### DETAILED DESCRIPTION OF THE INVENTION

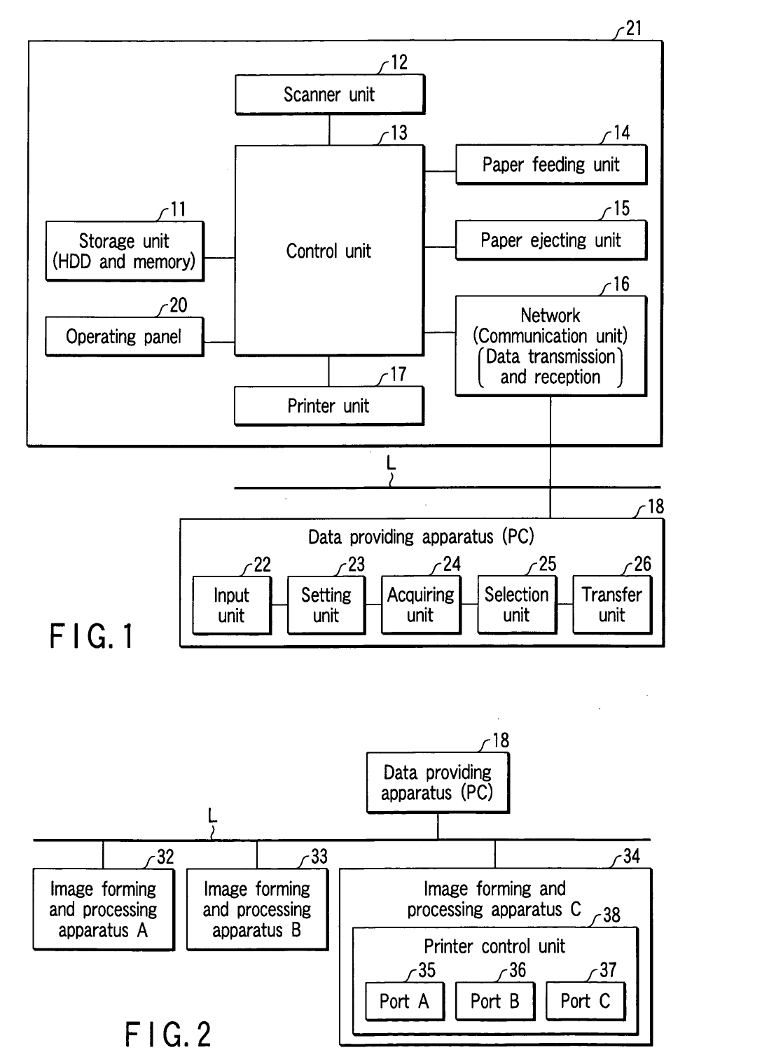

One embodiment of a data providing apparatus according to the invention will be described in detail referring to the accompanying drawings. FIG. 1 is a block diagram showing an example of a configuration of the data providing apparatus according to the invention and an image forming apparatus connected thereto, and FIG. 2 is an explanatory view showing the data providing apparatus according to the invention and a plurality of image forming apparatuses connected thereto through the network.

### DATA PROVIDING APPARATUS ACCORDING TO THE INVENTION AND IMAGE FORMING APPARATUS

(Image Forming Apparatus)

An image forming apparatus 21 forms images by receiving image data provided from a data providing apparatus 18 according to the invention. As shown in FIG. 1, the image forming apparatus 21 includes a control unit 13 which is connected to each unit and controls the overall operation, a storage unit 11 which has an HDD and a memory and temporarily stores the image data and the like, a scanner unit 12 which reads an original image or the like, a paper feeding unit 14 which feeds paper for the image forming, a paper ejecting unit 15 which ejects the paper in which the image has been formed, a network communication unit 16 which performs communication of the image data and the like through the network connected to the data providing apparatus 18, a printer unit 17 which forms images on the paper according to the given image data or the image data acquired by the scanner unit 12, and an operating panel 20 which supplies operation information for user's operation to the control unit 13. The data providing apparatus 18 according to the invention can provide printing data such as image data and a command signal to the image forming apparatus 21 and the like through the network such as Ethernet (R), and a personal computer (PC) operated by the user is one of examples of the data providing apparatus 18. It is possible that the image data and command signal to be provided are generated by, e.g., an application program of an operating system (OS) on the PC.

As shown in FIGS. 1 and 2, the data providing apparatus 18 includes an input unit 22 which inputs printing data, a setting unit 23 which sets selecting conditions, an acquiring unit 24 which acquires status information concerning a plurality of image forming apparatuses 32, 33, and 34 on a network L, a selection unit 25 which calculates evaluation of the plurality of image forming apparatuses on the basis of the selecting conditions and the plurality of status information and selects one image forming apparatus according to the calculation result, and a transfer unit 26 which transfers in order to provide the printing data to the one selected image forming apparatus. As described later, in the data providing apparatus 18, the printing data is automatically provided to the optimum image forming apparatus on the network by the selecting function which is unique to the invention.

### SELECTION PROCESSING OF DATA PROVIDING APPARATUS ACCORDING TO THE INVENTION

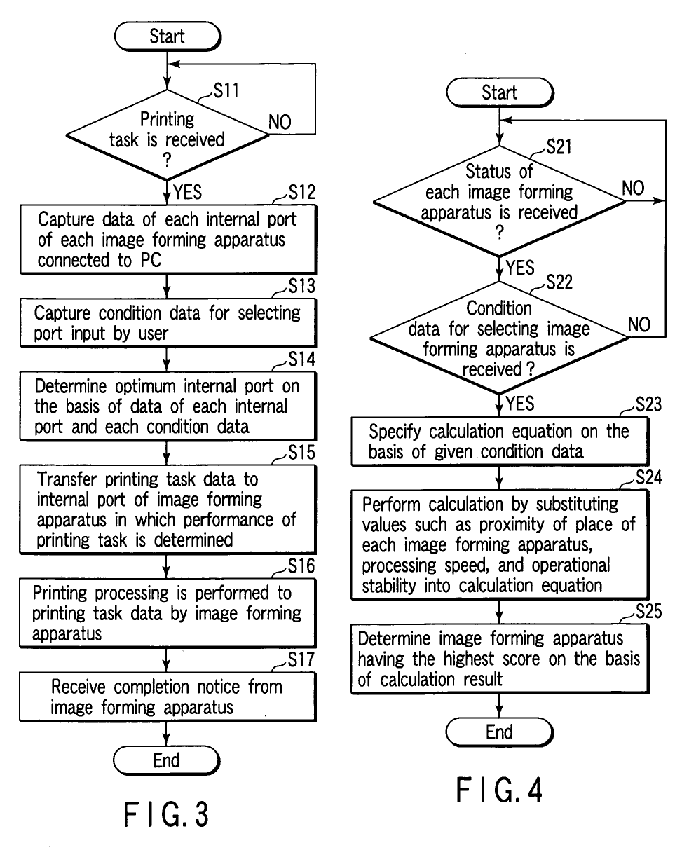

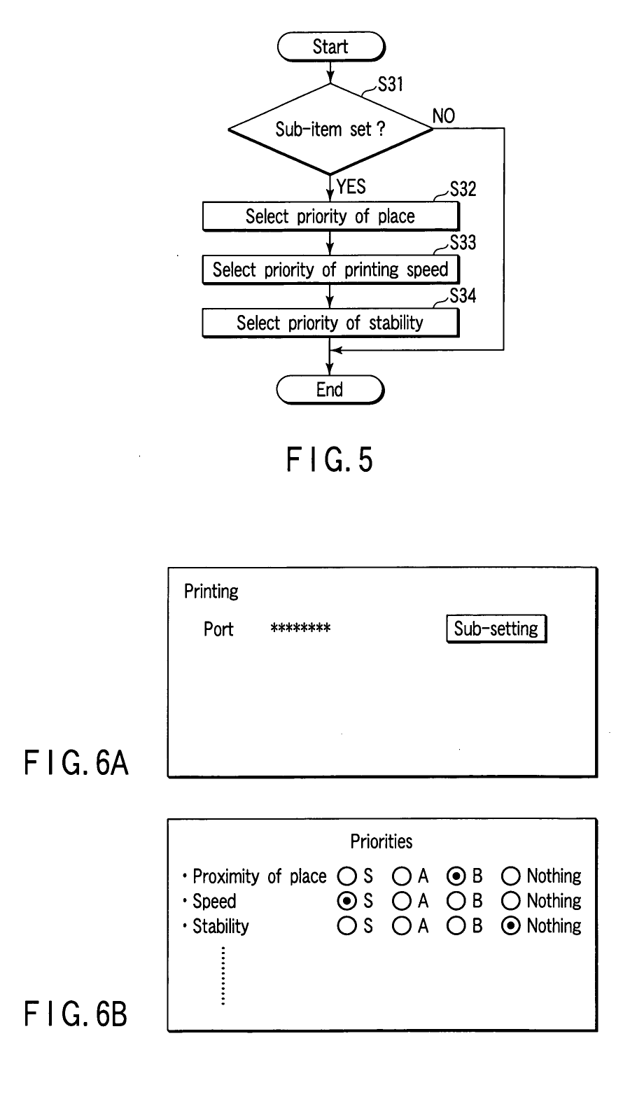

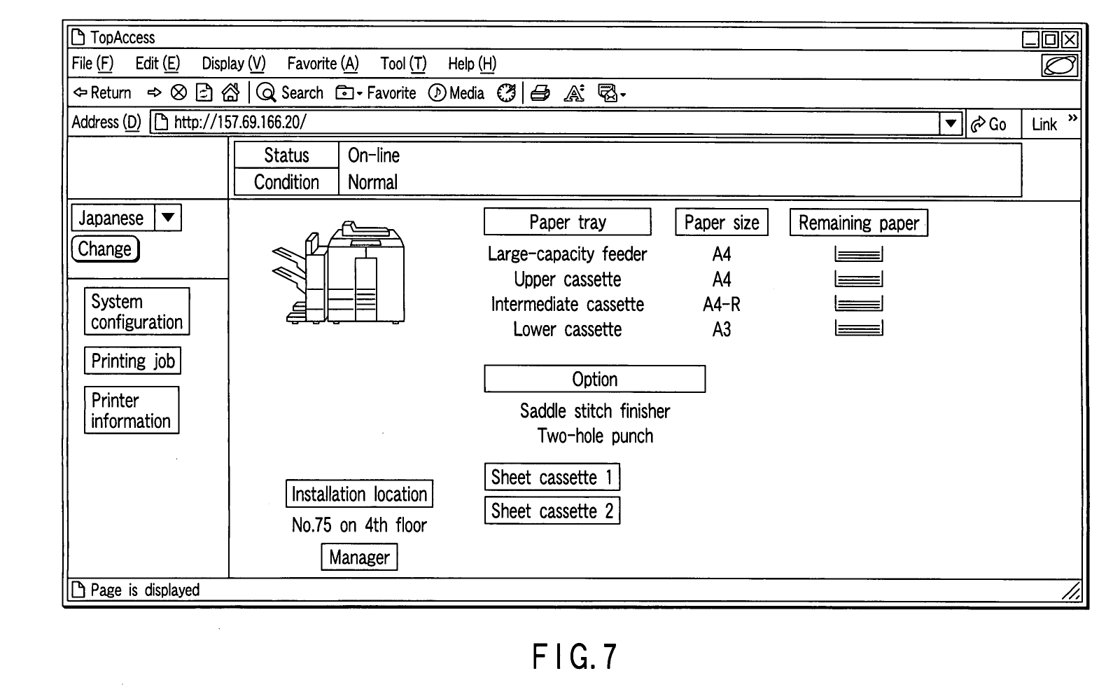

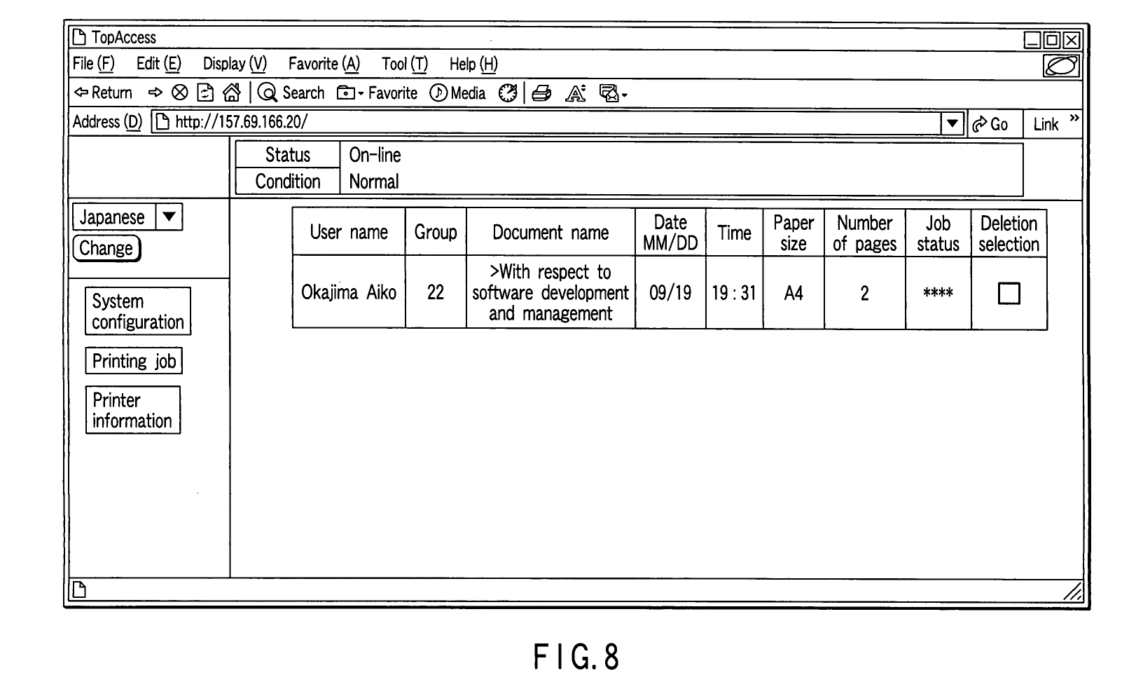

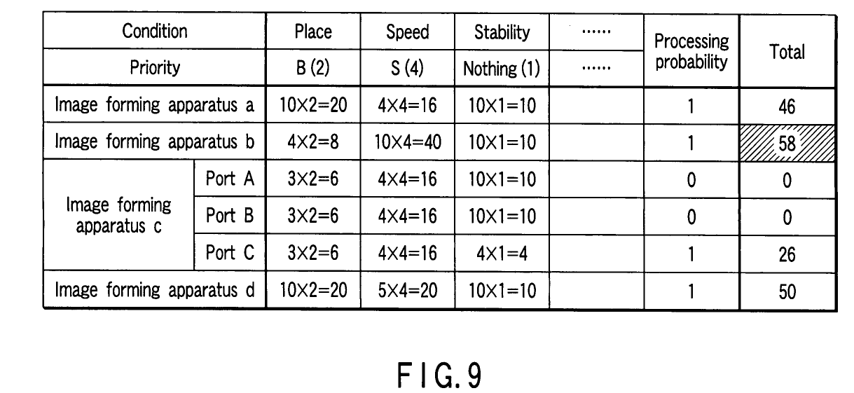

The providing operation of the data providing apparatus according to the invention will be described in detail by the use of the drawing such as a flowchart. FIG. 3 is a flowchart showing an example of the providing operation of the data providing apparatus according to the invention, FIG. 4 is a flowchart showing an example of the providing operation of the data providing apparatus according to the invention, FIG. 5 is a flowchart showing an example of the providing operation of the data providing apparatus according to the invention, FIGS. 6A and 6B are explanatory views showing an example of an operating screen of the data providing apparatus according to the invention, FIG. 7 is an explanatory view showing an example of a monitor screen for monitoring the image forming apparatus of the data providing apparatus according to the invention, FIG. 8 is an explanatory view showing another example of the monitor screen for monitoring the image forming apparatus of the data providing apparatus according to the invention, and FIG. 9 is a view showing an example of evaluation calculation of a plurality of candidates of the data providing apparatus according to the invention.

The data providing apparatus according to the invention is provided in the form of the application program provided under the operating system (OS) in the user's PC as one of the examples. It is also preferable that the data providing apparatus is provided in the form of a processing unit provided in the user's PC. In the data providing apparatus having the above configuration, in the case where there are a plurality of image forming apparatuses on the network, the printing data including the given image data to be printed, the command data, and the like is provided by automatically selecting the optimum image forming apparatus from setting information previously given and status information of the plurality of image forming apparatuses.

At this point, for example, a selection criterion is not that the operable image forming apparatus nearest the data providing apparatus is simply selected, but that sometimes a premium is put on a processing speed and the distance between the data providing apparatus and the image forming apparatus, that sometimes a premium is put on stability and processing speed, or that sometimes a premium is put on distance, processing speed, and the stability. That is, according to the setting information initially given from the user, the data providing apparatus 18 acquires the status information to automatically select the optimum image information apparatus. The selection operation will be described in detail specifically by the use of the flowchart.

In the flowchart shown in FIG. 3, at first the data providing apparatus 18 according to the invention determines whether a printing task is received by the input unit 22 or not (S11). The printing task may be given by directing that document data generated on the PC by the user should be printed by the user's operation. Then, the acquiring unit 24 captures the status information concerning each of the image forming apparatus 32, 33, and 34 on the network L connected to the data providing apparatus 18 into the data providing apparatus 18 (S12). As shown in FIG. 7, for example, the status information is that the machine is normally running in the on-line state, and that finisher and two-hole punch are set as an option. The status information also includes a paper size or a paper remaining amount of a paper tray. Further, as shown in FIG. 8, the status information includes the information concerning the printing task currently processed.

The setting unit 23 captures the selection information input by the user (S13). It is possible that the selection condition is set and changed by the user, and it is also possible to previously set an appropriate value concerning proximity of the image forming apparatus, processing speed, operational stability, or the like as a default.

The user can assign weights to the selection conditions from a sub-setting screen shown in FIG. 6B by calling the sub-setting screen from a calling screen of sub-setting of the selection conditions shown in FIG. 6A. Nothing is initially selected as the default in all items shown in FIG. 6B. At this point, when the user sets a sub-item in the flowchart of FIG. 5 (S31), the user selects “B” in the case where the premium is somewhat put on the proximity of the image forming apparatus for use in the printing (S32). The user selects “S” in the case where the premium is extremely put on the processing speed of the printing (S33). In the case where the premium is not put too much on the stability, the user leaves the sub-item of the stability as it is in the state of “nothing” (S34). Although only the proximity of the image forming apparatus, the processing speed of the printing, and the stability are described, it is preferable to set other items as the conditions of selecting one of the image forming apparatuses 32, 33, and 34.

The selection unit 25 determines the optimum image forming apparatus on the basis of the acquired status information and the selection information set by the user (S14). As shown in the flowchart of FIG. 4, the selection unit 25 fetches the status information of each internal port from a storage area (S21), and the selection unit 25 fetches the selection conditions of selecting the image forming apparatus from the storage area (S22). Then, the selection unit 25 specifies a calculation equation on the basis of the given status information and selection information (S23). It is preferable that the plurality of calculation equations are prepared in the storage area of the data providing apparatus 18 and the plurality of calculation equations are selected and used as appropriate on the basis of the status information and selection information.

FIG. 9 shows an example of the calculation equations and calculations for selecting the image forming apparatus. A score T is acquired for each of image forming apparatuses a, b, c, and s, and the score T is acquired in each of ports A, B, and C in the image forming apparatus c. A place D, speed V, and stability S are calculated with priorities P1, P2, and P3 respectively, and a processing probability A of the image forming apparatus is calculated. Then, Equation (1) for acquiring the score T becomes as follows:
T=(D·P1+V·P2+S·P3)×A (1)
However, the above equation is an example, and it is preferable that other calculation equations for other parameters are prepared in the storage area and the calculation is performed as appropriate according to the status information and selection condition.

The place D is a value corresponding to the distance from the place of the data providing apparatus 18 in which the user is present to the place of the target image forming apparatus. For example, the place D is evaluated in ten stages. Assuming that the image forming apparatus nearest the data providing apparatus is set to 10 points and farthest from the data providing apparatus is set to 0 points, it is preferable that the user previously sets the evaluation value corresponding to the distance of each image forming apparatus.

The speed V is a value which is evaluated depending on how long it takes finally (including waiting time) in the case where the image forming apparatus prints the printing data. For example, the speed V is evaluated in ten stages. Accordingly, it is necessary that the speed V is carefully determined according to contents of the status information and printing data which are previously acquired. The speed V is a value which is changed when the printing task in progress of the image forming apparatus is completed.

The processing time including the waiting time is determined by comparing the status information and the printing data, and the pre-defined score is given according to absolute time. For example, the score is 10 points when the processing time is within one minute, and the score is 19 points when the processing time ranges from one minute to two minutes. It is also preferable that 10 points are given to a first rank, 9 points are given to a second rank, and so or by determining the rank in candidates of the plurality of image forming apparatuses.

The stability S is a value obtained by evaluating a level in which the image forming apparatus has generated an error during a predetermined period in the past (for example, in the past day, or in the past week). For example, the stability S is evaluated in ten stages. It is possible to define the score according to the number of errors. It is also preferable that 10 points are given to the first rank, 9 points are given to the second rank, and the like by determining the rank in candidates of the plurality of image forming apparatuses.

The processing probability A is an item which means the case in which the printing can not be performed due to absence of A3 paper in the image forming apparatus A (evaluation of “0”) or the case in which the port A of the image forming apparatus c can not be used due to in use or trouble (evaluation of “0”), when the printing data requires the printing of the paper size of A3.

Then, the selection unit 25 determines the score of each image forming apparatus by the calculation in which the value of each item is substituted into the calculation equation specified in Step S23 (S24). That is, in FIG. 9, the place D, the speed V, and the stability S are previously set to B, S, and nothing, respectively, so that the coefficients P1, P2, and P3 become 2, 4, and 1, respectively.

The score of the image forming apparatus a becomes as follows:
T=(10×2+4×4+10×1)×1=46
Similarly, the score of the image forming apparatus b becomes as follows:
T=(4×2+10×4+10×1)×1=58
The score of the image forming apparatus c can be acquired in each port.
T=(3×2+4×4+10×1)×0=0
T=(3×2+4×4+10×1)×0=0
T=(3×2+4×4+4×1)×1=26
At this point, the ports A and B are in use, and the score of the ports A and B become “0” in the processing probability.
The score of the image forming apparatus d becomes as follows:
T=(10×2+5×4+10×1)×1=50
The image forming apparatus b is determined as the providing address of the printing data as a result of the above calculations (S25). It is preferable to inform the user of the image forming apparatus of the determined providing address by display the image forming apparatus on the screen of PC which is of the data providing apparatus 18.

In this case, since the priorities are given such that “the place is B, the speed is S, and the stability is nothing,” assuming that the highest priority is put on speed, a priority is also put on the place, and the premium is not put on the stability, the image forming apparatus B on the network is automatically selected.

When the providing address is determined, the transfer unit 26 returns to the flowchart of FIG. 3, and the printing task data is transferred to the internal port of the image forming apparatus in which the performance of the printing task is determined through the network L (S15). The image forming apparatus b to which the printing task data has been transferred performs the printing processing according to the printing task data (S16). When the printing processing is completed, the data providing apparatus 18 receives a completion notice signal from the image forming apparatus B through the network L (S17).

In the data providing apparatus and the data providing method according to the invention, when the printing processing is performed, the optimum image forming apparatus is automatically selected from the image forming apparatuses on the network by taking the above-described procedure. That is, in selecting the image forming apparatus, every time the user does not check the status of the image forming apparatus to select the optimum image forming apparatus, but the image forming apparatus on the network is automatically selected, the printing data is transferred, and the printing is started, by the use of the selection criterion in which the highest priority is put on the speed, a priority is also put on place, and a premium is not put on stability by giving priorities such as “place (B), speed (S), and stability (nothing).” Therefore, when the user once sets the selection criterion, the user can perform the printing processing with the image forming apparatus on the network which is of the image forming apparatus nearest the user's desire by giving the usual printing direction.

Those skilled in the art can realize the invention by the various embodiments described above. Further, various modifications of the embodiments could be easily conceived by those skilled in the art, and the invention can be applied to various embodiments without any inventive ability. Therefore, it is to be understood that the invention covers the broad scope which is consistent with the disclosed principle and the novel feature and the invention is not limited to the above-described embodiments.

1. A data providing apparatus comprising:
an input unit which inputs printing data;
a setting unit which sets a selection condition;
an acquiring unit which is connected to a network, and acquires a plurality of status information concerning a plurality of image forming apparatuses on the network;
a selection unit which calculates evaluation of said plurality of image forming apparatuses on the basis of the selection condition and said plurality of status information, and selects one image forming apparatus according to calculation result; and
a transfer unit which transfers the printing data input by the input unit in order to provide the printing data to said one image forming apparatus selected by the selection unit.

2. A data providing apparatus according to claim 1, wherein the selection unit determines the calculation results by also referring to specifications of the printing data input by the input unit.

3. A data providing apparatus according to claim 1, wherein the selection condition which is considered by the selection unit is at least one of a distance from the data providing apparatus to the image forming apparatus, printing time of the image forming apparatus, and stability of printing processing of the image forming apparatus.

4. A data providing apparatus according to claim 1, further comprising:
a setting unit which sets a priority concerning the distance from the data providing apparatus to the image forming apparatus, the printing time of the image forming apparatus, and the stability of the printing processing of the image forming apparatus, which are of the selection condition.

5. A data providing apparatus according to claim 4, wherein a user can arbitrarily set a value of the priority of the setting unit.

6. A data providing apparatus according to claim 1, wherein the distance from the data providing apparatus to the image forming apparatus, which is one of the selection conditions of the selection unit, is the value set by the user.

7. A data providing apparatus according to claim 1, wherein the selection condition of the setting unit includes the printing time of the image forming apparatus, and the printing time is a printing schedule time calculated in consideration of paper, the number of printing sheets, a printing mode, which are specified by the printing data, and said plurality of status information of said plurality of image forming apparatuses of the network.

8. A data providing apparatus according to claim 1, wherein the selection condition of the setting unit includes the stability of the printing processing of the image forming apparatus, and the stability is determined on the basis of how many the image forming apparatus has generated an error during a predetermined period in the past.

9. A data providing apparatus according to claim 1, wherein the calculation result of the selection unit is determined in consideration of whether the image forming apparatus can process a task shown by the printing data or not.

10. A data providing apparatus according to claim 1, wherein the calculation of the evaluation of the selection unit is performed not only to each of said plurality of image forming apparatuses, but also to a plurality of ports which are included in the image forming apparatus.

11. A data providing method comprising:
acquiring a plurality of status information concerning a plurality of image forming apparatuses on a network;
setting a selection condition for selecting one image forming apparatus from said plurality of image forming apparatuses in order to print given printing data;
calculating evaluation of said plurality of image forming apparatuses on the basis of the selection condition and said plurality of status information, and selecting one image forming apparatus according to calculation result; and
transferring the printing data in order to provide the printing data to the selected image forming apparatus.

12. A data providing method according to claim 11, wherein the calculation processing for the selection is performed by also referring to specifications of the printing data input by the input unit.

13. A data providing method according to claim 11, wherein the selection condition is at least one of a distance from the data providing method to the image forming apparatus, printing time of the image forming apparatus, and stability of printing processing of the image forming apparatus.

14. A data providing method according to claim 11, further comprising:
setting a priority concerning the distance from the data providing apparatus to the image forming apparatus, the printing time of the image forming apparatus, and the stability of the printing processing of the image forming apparatus, which are of the selection condition.

15. A data providing method according to claim 14, wherein a user can arbitrarily set a value of the priority.

16. A data providing method according to claim 11, wherein the distance from the data providing method to the image forming apparatus, which is of the selection condition, is one whose value is set by the user.

17. A data providing method according to claim 11, wherein the selection condition includes the printing time of the image forming apparatus, and the printing time is a printing schedule time calculated in consideration of paper, the number of printing sheets, and a printing mode, which are specified by the printing data, and said plurality of status information of the network.

18. A data providing method according to claim 11, wherein the selection condition includes the stability of the printing processing of the image forming apparatus, and the stability is determined on the basis of how many the image forming apparatus has generated an error during a predetermined period in the past.

19. A data providing method according to claim 11, wherein the calculation result is determined in consideration of whether the image forming apparatus can process a task shown by the printing data or not.

20. A data providing method according to claim 11, wherein the calculation processing for the evaluation is performed not only to each of said plurality of image forming apparatuses, but also to a plurality of ports which are included in the image forming apparatus.
